(19) United States
(12) Patent Application Publication
(10) Pub. No.: US 2024/0207874 A1
(43) Pub. Date: Jun. 27, 2024

(54) LIQUID DISPENSING DEVICE

(71) Applicant: FUNAI ELECTRIC CO., LTD., Osaka (JP)

(72) Inventors: HIDEKI TANABE, Osaka (JP); FUTOSHI TAKEDA, Osaka (JP)

(73) Assignee: FUNAI ELECTRIC CO., LTD., Osaka (JP)

(21) Appl. No.: 18/505,056

(22) Filed: Nov. 8, 2023

(30) Foreign Application Priority Data
Dec. 21, 2022 (JP) 2022-204393

(51) Int. Cl. B05B 5/025

(52) U.S. Cl. CPC B05B 5/025

(57) ABSTRACT

A liquid dispensing device includes: a discharge part, discharging liquid toward a well of a well plate; and an opening plate, arranged between the discharge part and the well plate and having an opening formed therein corresponding to the well. The opening is smaller in size than the well when the opening plate is viewed in an XY plane.

### CROSS-REFERENCE TO RELATED APPLICATIONS

This application claims the priority benefit of Japan Application No. 2022-204393, filed on Dec. 21, 2022. The entirety of the above-mentioned patent application is hereby incorporated by reference herein and made a part of this specification.

### BACKGROUND

### Technical Field

The disclosure relates to a liquid dispensing device that dispenses liquid to a well plate.

### Related Art

There is known a liquid dispensing device that dispenses a liquid such as a sample or a specimen to a well plate (see, for example, Japanese Patent No. 6446151). In this liquid dispensing device, a predetermined amount of droplets (liquid) are discharged from an inkjet head toward each of a plurality of wells formed in an upper surface of the well plate.

In the conventional liquid dispensing device described above, when the droplets are discharged toward a well, there is a risk that the droplets may float up from this well and scatter to a well around this well due to an airflow generated within this well. As a result, a problem arises in that different droplets mix in each well, resulting in so-called contamination.

### SUMMARY

A liquid dispensing device according to one aspect of the disclosure dispenses a liquid to a well plate having a well formed in an upper surface. The liquid dispensing device includes: a discharge part, discharging the liquid toward the well; and an opening plate, arranged between the discharge part and the well plate and having an opening formed therein corresponding to the well. The opening is smaller in size than the well in a plan view of the opening plate.

### BRIEF DESCRIPTION OF THE DRAWINGS

FIG. 1 is a perspective view schematically illustrating an internal structure of a liquid dispensing device according to Embodiment 1.

FIG. 2 is an exploded perspective view illustrating a well plate and an opening plate of the liquid dispensing device according to Embodiment 1.

FIG. 3 is a plan view illustrating the well plate of the liquid dispensing device according to Embodiment 1.

FIG. 4 is a plan view illustrating the opening plate of the liquid dispensing device according to Embodiment 1.

FIG. 5 is a cross-sectional view illustrating an essential part of the liquid dispensing device according to Embodiment 1, taken along line V-V in FIG. 4.

FIG. 6 is a cross-sectional view illustrating an essential part of the liquid dispensing device according to Embodiment 1, taken along line VI-VI in FIG. 4.

FIG. 7 is a cross-sectional view illustrating an essential part of a liquid dispensing device according to a comparative example.

FIG. 8 is a cross-sectional view illustrating an essential part of a liquid dispensing device according to a modification of Embodiment 1.

FIG. 9 is a cross-sectional view illustrating an essential part of a liquid dispensing device according to Embodiment 2.

FIG. 10 is a plan view illustrating a lower surface side of an opening plate of a liquid dispensing device according to Embodiment 3.

FIG. 11 is a plan view illustrating an upper surface side of the opening plate of the liquid dispensing device according to Embodiment 3.

FIG. 12 is a cross-sectional view illustrating an essential part of the liquid dispensing device according to Embodiment 3, taken along line XII-XII in FIG. 11.

FIG. 13 is a cross-sectional view illustrating an essential part of the liquid dispensing device according to Embodiment 3, taken along line XIII-XIII in FIG. 11.

### DESCRIPTION OF THE EMBODIMENTS

The disclosure provides a liquid dispensing device in which contamination can be reduced.

A liquid dispensing device according to a first aspect of the disclosure dispenses a liquid to a well plate having a well formed in an upper surface. The liquid dispensing device includes: a discharge part, discharging the liquid toward the well; and an opening plate, arranged between the discharge part and the well plate and having an opening formed therein corresponding to the well. The opening is smaller in size than the well in a plan view of the opening plate.

According to the present aspect, the opening plate is arranged between the discharge part and the well plate, and the opening is smaller in size than the well in a plan view of the opening plate. Accordingly, when the liquid is discharged from the discharge part through the opening of the opening plate toward the well directly below the opening, most of an airflow generated inside the well may bounce off an outer periphery of the opening to thereby circulate inside the well. Hence, almost no airflow is generated to flow outside the well through the opening, and a situation in which some of droplets discharged into the well float up from the well and scatter to, for example, wells around the well, can be reduced. As a result, contamination can be reduced.

For example, in the liquid dispensing device according to a second aspect of the disclosure, in the first aspect, in a plan view of the opening plate, the opening may be configured to be smaller in size than the well, and an outline of the opening may be configured to be arranged inside an outline of the well.

According to the present aspect, since the outer periphery of the opening of the opening plate protrudes in an annular and eave-like shape inside the well over the entire circumference of the well, contamination can be relatively effectively reduced.

For example, in the liquid dispensing device according to a third aspect of the disclosure, in the first aspect or the second aspect, a lower surface of the opening plate facing the well plate may be configured to have water repellency.

According to the present aspect, a droplet attached to the lower surface of the opening plate can be caused to drip into the well by its own weight.

For example, in the liquid dispensing device according to a fourth aspect of the disclosure, in the third aspect, the lower surface of the opening plate may be configured to have water repellency with a contact angle of 90° or more.

According to the present aspect, a droplet attached to the lower surface of the opening plate can be caused to easily drip into the well by its own weight.

According to the present aspect, for example, in the liquid dispensing device according to a fifth aspect of the disclosure, in any one of the first to fourth aspects, the opening plate may be configured to be made of a conductive material.

According to the present aspect, even if the opening plate is charged, charges on the opening plate can be discharged into the atmosphere. As a result, in the case where droplets discharged from the discharge part are charged, it can be prevented that the droplets repel against the charges on the opening plate and scatter to the outside of the well.

For example, in the liquid dispensing device according to a sixth aspect of the disclosure, in any one of the first to fifth aspects, on the lower surface of the opening plate facing the well plate, a first electrode may be configured to be arranged on the outer periphery of the opening, and the first electrode may be configured to be grounded.

According to the present aspect, even if the opening plate is charged, the charges on the opening plate can be flowed from the first electrode to the ground. As a result, in the case where droplets discharged from the discharge part are charged, it can be prevented that the droplets repel against the charges on the opening plate and scatter to the outside of the well.

For example, in the liquid dispensing device according to a seventh aspect of the disclosure, in the sixth aspect, on an upper surface of the opening plate opposite to the well plate, a second electrode may be configured to be arranged on the outer periphery of the opening, and the second electrode may be configured to be grounded.

According to the present aspect, even if the opening plate is charged, the charges on the opening plate can be flowed from the second electrode to the ground. As a result, in the case where droplets discharged from the discharge part are charged, it can be prevented that the droplets repel against the charges on the opening plate and scatter to the outside of the well.

For example, in the liquid dispensing device according to an eighth aspect of the disclosure, in any one of the first to seventh aspects, a barb curved toward the well may be configured to be formed on the outer periphery of the opening.

According to the present aspect, when droplets are discharged from the discharge part through the opening toward the well directly below the opening, an airflow generated inside the well is able to effectively bounce off the barb formed on the outer periphery of the opening. As a result, contamination can be relatively effectively reduced.

According to the liquid dispensing device according to one aspect of the disclosure, contamination can be reduced.

Hereinafter, embodiments of the disclosure will be described in detail using the drawings. All of the embodiments described hereinafter show general or specific examples. The numerical values, shapes, materials, components, arrangement positions and connection forms of the components and so on shown in the following embodiments are examples and do not intend to limit the disclosure. Among the components in the following embodiments, the components not recited in the independent claims are described as arbitrary components.

### Embodiment 1

### [1. Overall Configuration of Liquid Dispensing Device]

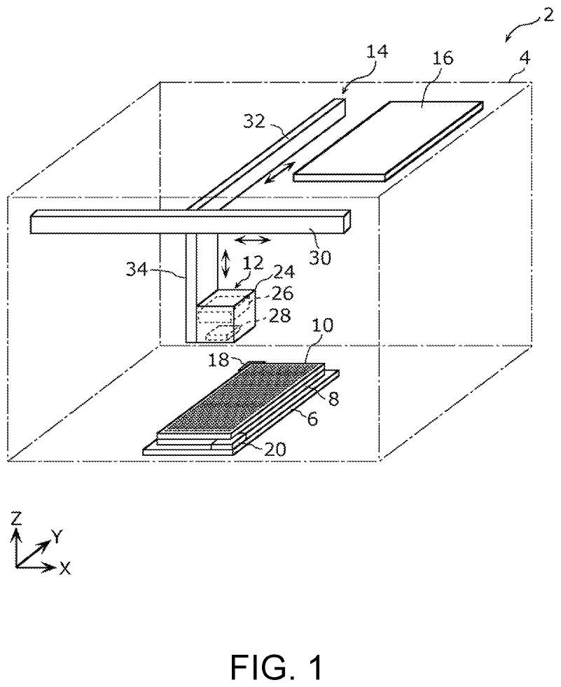

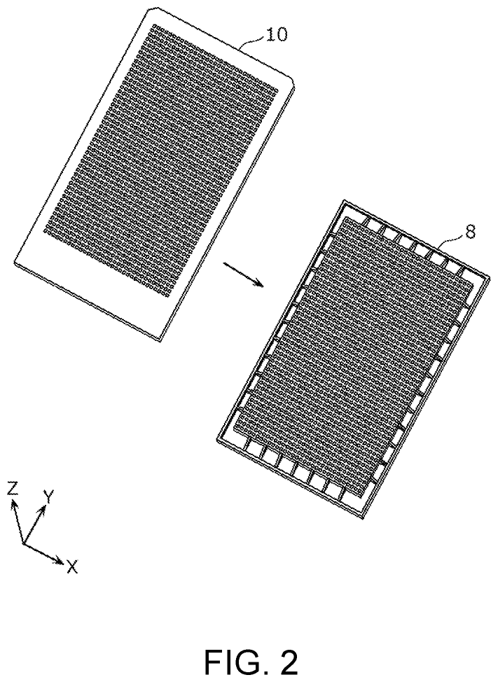

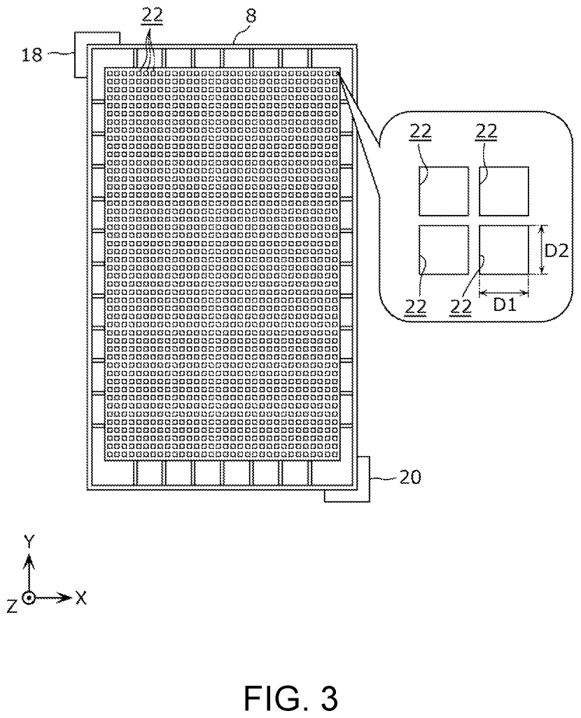

An overall configuration of a liquid dispensing device 2 according to Embodiment 1 is described with reference to FIG. 1 to FIG. 3. FIG. 1 is a perspective view schematically illustrating an internal structure of the liquid dispensing device 2 according to Embodiment 1. FIG. 2 is an exploded perspective view illustrating a well plate 8 and an opening plate 10 of the liquid dispensing device 2 according to Embodiment 1. FIG. 3 is a plan view illustrating the well plate 8 of the liquid dispensing device 2 according to Embodiment 1.

In FIG. 1, a left-right direction of the liquid dispensing device 2 is the X axis, a front-back direction of the liquid dispensing device 2 is the Y axis, and an up-down direction of the liquid dispensing device 2 is the Z axis. In this specification, a positive side of the Z axis is “up”, and a negative side of the Z axis is “down”.

As illustrated in FIG. 1, the liquid dispensing device 2 includes a housing 4, a tray 6, the well plate 8, the opening plate 10, a discharge part 12, a drive mechanism 14, and a controller 16. The liquid dispensing device 2 is a device for dispensing liquid to the well plate 8. The liquid is, for example, a sample, a specimen or a reagent used in a test or the like in the medical field or the physical and chemical fields.

The housing 4 is formed in a hollow box shape. An opening (not illustrated) for putting in and out the well plate 8 is formed in a front surface of the housing 4.

The tray 6 is for placing the well plate 8, and is movably supported by a guide plate (not illustrated) arranged inside the housing 4. Accordingly, the tray 6 is movable along the guide plate between a storage position (the position of the tray 6 illustrated in FIG. 1) where the tray 6 is stored inside the housing 4 and a pull-out position (not illustrated) where the tray 6 is pulled out to a near side (negative side of the Y axis) through the opening of the housing 4.

A pair of guide walls 18 and 20 for positioning the well plate 8 with respect to the tray 6 are arranged on an upper surface of the tray 6. Each of the pair of guide walls 18 and 20 is formed in a substantially L-shape as viewed in an XY plane. The pair of guide walls 18 and 20 respectively contact a pair of diagonal corners among four corners of the well plate 8.

As illustrated in FIG. 2 and FIG. 3, the well plate 8 is, for example, formed in a substantially rectangular plate shape as viewed in the XY plane and made of resin or the like. The well plate 8 is removably placed on the upper surface of the tray 6. In an upper surface of the well plate 8, a plurality of wells 22 for storing droplets (liquid) discharged from the discharge part 12 are formed in a matrix (for example, 32 rows×48 columns). Each of the plurality of wells 22 is, for example, a recess formed in a rectangular shape as viewed in the XY plane. The number of wells 22 formed in one well plate 8 is, for example, 1536 (=32×48). In a plan view of the XY plane, a horizontal (X-axis direction) length D1 of each well 22 is, for example, 1.7 mm, and a vertical (Y-axis direction) length D2 of each well 22 is, for example, 1.7 mm.

In the present embodiment, the number of wells 22 formed in one well plate 8 is 1536. However, the disclosure is not limited thereto, and the number of wells 22 may be, for example, 24 (=4×6), 96 (=8×12), or 384 (=16×24). As the number of wells 22 increases, an arrangement interval between the wells 22 decreases and the size of the wells 22 decreases.

The opening plate 10 is a plate for reducing contamination in the well plate 8. As illustrated in FIG. 1 and FIG. 2, the opening plate 10 is arranged to cover the upper surface of the well plate 8. That is, the opening plate 10 is arranged between the well plate 8 and the discharge part 12. A specific configuration of the opening plate 10 will be described later.

The discharge part 12 is a unit for discharging droplets toward one or more of the plurality of wells 22 of the well plate 8, and is arranged inside the housing 4. A method of discharging droplets by the discharge part 12 is an inkjet method in which mist-like droplets are discharged.

As illustrated in FIG. 1, the discharge part 12 includes a carriage 24, a cartridge 26, and a nozzle 28. The cartridge 26 is removably mounted in the carriage 24. The inside of the cartridge 26 is filled with one or more types of liquid to be dispensed to the well plate 8. The nozzle 28 is arranged at a lower end of the carriage 24. A plurality of fine nozzle holes are formed in the nozzle 28. In the discharge part 12, a liquid supplied from the cartridge 26 is discharged in the form of mist-like droplets from the nozzle 28 toward the upper surface of the well plate 8 placed on the tray 6 in the storage position.

The drive mechanism 14 includes an X-axis mechanism 30, a Y-axis mechanism 32, and a Z-axis mechanism 34, and is arranged inside the housing 4. The X-axis mechanism 30 is a mechanism for moving the discharge part 12 in a scanning direction (X-axis direction). The Y-axis mechanism 32 is a mechanism for moving the discharge part 12 in a sub-scanning direction (Y-axis direction). The Z-axis mechanism 34 is a mechanism for moving the discharge part 12 in the up-down direction (Z-axis direction).

The controller 16 is for controlling the discharge part 12 and the drive mechanism 14, and is arranged inside the housing 4.

While the discharge part 12 is moving in the sub-scanning direction and reciprocating in the scanning direction, by discharging droplets from the discharge part 12 onto the upper surface of the well plate 8, a predetermined amount (for example, amount on the order of picoliters) of liquid is stored in each of the plurality of wells 22 of the well plate 8. Accordingly, the liquid is dispensed to the well plate 8. In one discharge of droplets from the discharge part 12, the droplets may be dispensed into each of several to more than ten wells 22 at once, or may be dispensed only to a single well 22.

After the liquid is dispensed to the well plate 8, a user, after moving the tray 6 from the storage position to the pull-out position, is able to take out the well plate 8 from the tray 6 by removing the opening plate 10 from the well plate 8. The liquid stored in each of the plurality of wells 22 of the well plate 8 is used, for example, for analysis.

### [2. Configuration of Opening Plate]

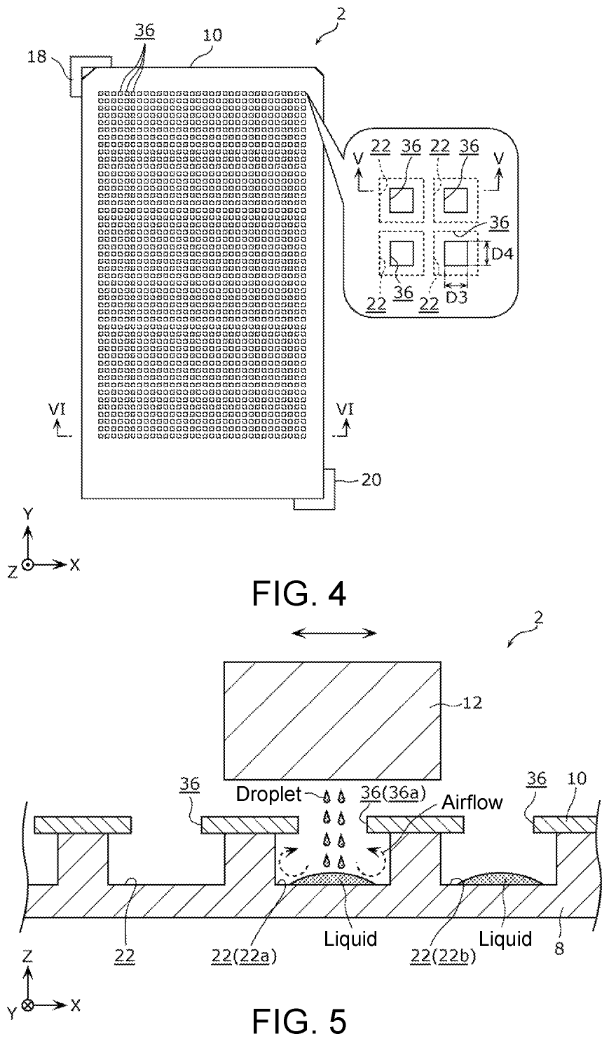

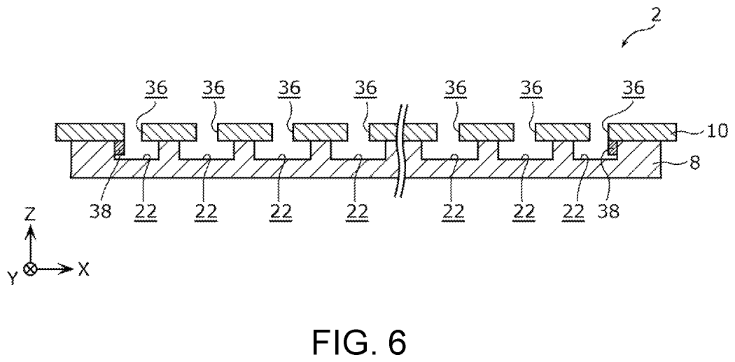

Next, a configuration of the opening plate 10 is described with reference to FIG. 4 to FIG. 6. FIG. 4 is a plan view illustrating the opening plate 10 of the liquid dispensing device 2 according to Embodiment 1. FIG. 5 is a cross-sectional view illustrating an essential part of the liquid dispensing device 2 according to Embodiment 1, taken along line V-V in FIG. 4. FIG. 6 is a cross-sectional view illustrating an essential part of the liquid dispensing device 2 according to Embodiment 1, taken along line VI-VI in FIG. 4.

As illustrated in FIG. 4, the opening plate 10 is, for example, formed in a substantially rectangular plate shape as viewed in the XY plane and made of resin or the like. In the opening plate 10, a plurality of openings 36 are formed in a matrix (for example, 32 rows×48 columns) corresponding to the plurality of wells 22 of the well plate 8. That is, the plurality of openings 36 correspond to the plurality of wells 22 on a one-to-one basis. The number of openings 36 formed in one opening plate 10 is the same as the number of wells 22, and is, for example, 1536 (=32×48). Each of the plurality of openings 36 is formed in, for example, a rectangular shape as viewed in the XY plane.

For example, if the number of wells 22 formed in one well plate 8 is 24, 96, or 384, the number of openings 36 formed in one opening plate 10 is 24, 96, or 384, respectively, which is the same as the number of wells 22.

The plurality of openings 36 are respectively arranged directly above the plurality of wells 22. Specifically, when the opening plate 10 is viewed in the XY plane, the size (area) of each of the plurality of openings 36 is smaller than the size (area) of each of the plurality of wells 22, and an outline of each of the plurality of openings 36 is arranged inside an outline of each of the plurality of wells 22. In a plan view of the XY plane, a horizontal (X-axis direction) length D3 of each opening 36 is, for example, 1.0 mm (<D1), and a vertical (Y-axis direction) length D4 of each opening 36 is, for example, 1.0 mm (<D2). As illustrated in FIG. 5, an outer periphery of the opening 36 protrudes in an annular and eave-like shape inside the well 22 over the entire circumference of the well 22. Accordingly, the droplets from the discharge part 12 may be discharged through the opening 36 of the opening plate 10 toward the well 22 directly below the opening 36.

A lower surface (that is, the surface facing the well plate 8) of the opening plate 10 has water repellency. In this case, a water-repellent coating may be applied to the lower surface of the opening plate 10, or the opening plate 10 itself may be made of a water-repellent material. As the water-repellent coating, a fluorine-based surfactant, for example, can be used. As the water-repellent material, a material obtained by adding fluorine or a silicone polymer to a resin, for example, can be used. The lower surface of the opening plate 10 preferably has water repellency with a contact angle of 90° or more.

As illustrated in FIG. 6, on the lower surface of the opening plate 10, a positioning protrusion 38 protruding toward the well 22 is formed on the outer periphery of the opening 36 arranged in a corner among the plurality of openings 36. When the opening plate 10 is placed on the upper surface of the well plate 8, the positioning protrusion 38 is removably inserted into the well 22, thereby positioning the opening plate 10 with respect to the well plate 8. Accordingly, the plurality of openings 36 may each be arranged directly above each of the plurality of wells 22.

### [3. Effects]

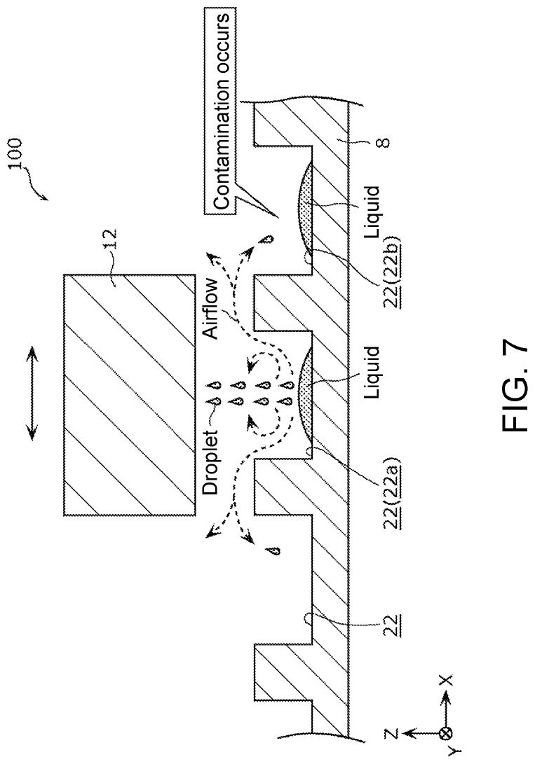

Here, a configuration of a liquid dispensing device 100 according to a comparative example is described with reference to FIG. 7. FIG. 7 is a cross-sectional view illustrating an essential part of the liquid dispensing device 100 according to a comparative example. In FIG. 7, the same components as those in Embodiment 1 are assigned the same reference numerals, and the description thereof will be omitted.

As illustrated in FIG. 7, since the liquid dispensing device 100 according to the comparative example does not include the opening plate 10 described above, the following problems occur. When droplets are discharged from the discharge part 12 toward a well 22 (hereinafter referred to as “well 22a”) of the well plate 8, an airflow arising from the discharge of droplets may be generated inside the well 22a. This airflow is generated so as not only to circulate inside the well 22a but also to flow outside the well 22a. Hence, there is a risk that some of the droplets discharged to the well 22a may float up from the well 22a and scatter to a well 22 (hereinafter referred to as “well 22b”) around the well 22a due to the airflow flowing outside the well 22a. As a result, a problem arises in that different droplets mix in the well 22b, resulting in so-called contamination.

In contrast, since the liquid dispensing device 2 according to the present embodiment includes the opening plate 10, the following effects are achieved. As described above, the outer periphery of the opening 36 of the opening plate 10 protrudes in an annular and eave-like shape inside the well 22 over the entire circumference of the well 22 of the well plate 8.

Accordingly, as illustrated in FIG. 5, when the droplets are discharged from the discharge part 12 through an opening 36 (hereinafter referred to as “opening 36a”) of the opening plate 10 toward the well 22 (hereinafter referred to as “well 22a”) directly below the opening 36a, most of the airflow generated inside the well 22a may bounce off an outer periphery of the opening 36a to thereby circulate inside the well 22a. Hence, almost no airflow is generated to flow outside the well 22a through the opening 36a, and a situation in which some of the droplets discharged into the well 22a float up from the well 22a and scatter to the well 22 (hereinafter referred to as “well 22b”) around the well 22a can be reduced. As a result, occurrence of contamination in the well plate 8 can be reduced.

As described above, the lower surface of the opening plate 10 has water repellency. Accordingly, even if some of the droplets discharged into the well 22a are carried by the airflow circulating inside the well 22a and thus adhere to the outer periphery of the opening 36a in the lower surface of the opening plate 10, these droplets can be caused to drip into the well 22a by their own weight.

### [4. Modifications]

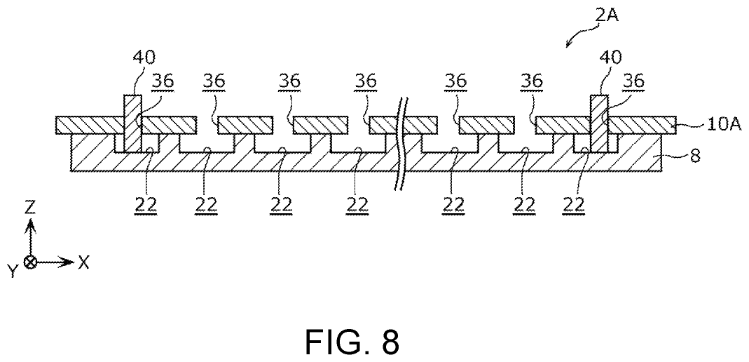

A configuration of a liquid dispensing device 2A according to a modification of Embodiment 1 is described with reference to FIG. 8. FIG. 8 is a cross-sectional view illustrating an essential part of the liquid dispensing device 2A according to a modification of Embodiment 1. FIG. 8 is a cross-sectional view illustrating an essential part of the liquid dispensing device 2A taken along a cutting line corresponding to line VI-VI in FIG. 4. In the present modification, the same components as those in Embodiment 1 are assigned the same reference numerals, and the description thereof will be omitted.

As illustrated in FIG. 8, in the liquid dispensing device 2A of the present modification, the positioning protrusion 38 described above is not formed on a lower surface of an opening plate 10A. That is, the liquid dispensing device 2A includes a positioning pin 40 instead of the positioning protrusion 38 described above. Through the opening 36 arranged in a corner among a plurality of openings 36 of the opening plate 10A, the positioning pin 40 is removably inserted through the well 22 directly below the opening 36. A lower end of the positioning pin 40 is in contact with a bottom of the well 22.

Accordingly, as in Embodiment 1, the opening plate 10A is positioned with respect to the well plate 8. If the user experiences a feeling that the lower end of the positioning pin 40 is in contact with the bottom of the well 22 when inserting the positioning pin 40 into the opening 36, it can be determined that the opening plate 10A is correctly positioned.

It is sufficient if the positioning pin 40 can be pulled out from the well 22 after the opening plate 10A is positioned with respect to the well plate 8. Accordingly, the droplets from the discharge part 12 can be discharged also into the well 22 into which the positioning pin 40 has been inserted. Alternatively, the positioning pin 40 may be left inserted through the well 22 after the opening plate 10A is positioned with respect to the well plate 8.

### Embodiment 2

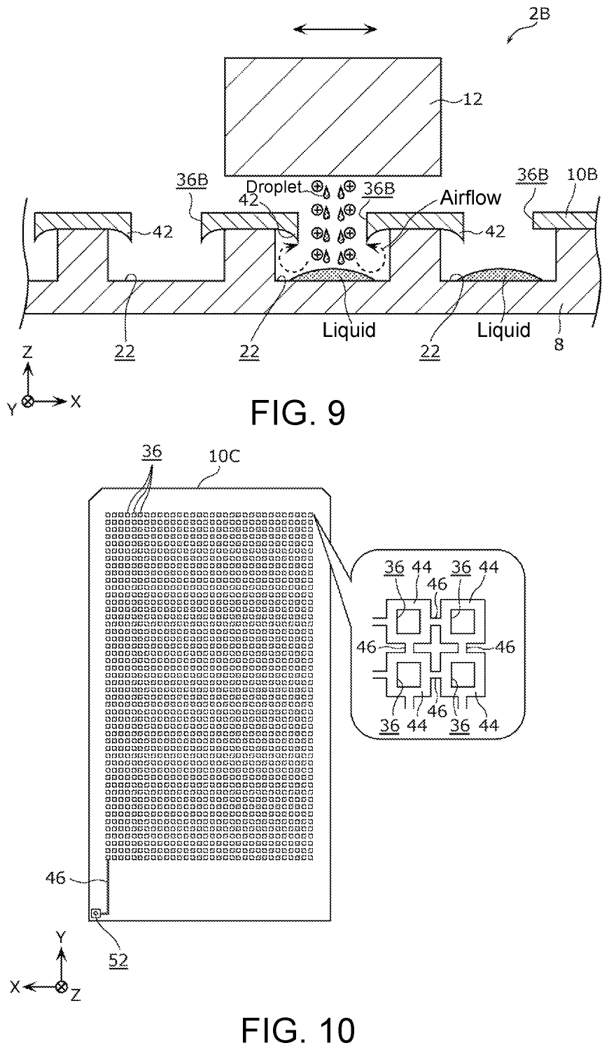

A configuration of a liquid dispensing device 2B according to Embodiment 2 is described with reference to FIG. 9. FIG. 9 is a cross-sectional view illustrating an essential part of the liquid dispensing device 2B according to Embodiment 2. FIG. 9 is a cross-sectional view illustrating an essential part of the liquid dispensing device 2B taken along a cutting line corresponding to line V-V in FIG. 4. In each embodiment illustrated below, the same components as those in Embodiment 1 are assigned the same reference numerals, and the description thereof will be omitted.

As illustrated in FIG. 9, in the liquid dispensing device 2B, an opening plate 10B is made of, for example, a conductive material such as metal, silicon, or carbon. Accordingly, for example, when the opening plate 10B is taken out from a plastic packaging bag or the like, even if the opening plate 10B is charged with charges (for example, positive charges), the charges on the opening plate 10B can be discharged into the atmosphere. As a result, in the case where the droplets discharged from the discharge part 12 are charged with charges (for example, positive charges), it can be prevented that these droplets repel against the charges on the opening plate 10B and scatter to the outside of the well 22.

As illustrated in FIG. 9, in the liquid dispensing device 2B, a barb 42 is formed on an outer periphery of each of a plurality of openings 36B of the opening plate 10B. The barb 42 is curved toward the well 22 over the entire circumference of the opening 36B. Accordingly, when droplets are discharged from the discharge part 12 through the opening 36B toward the well 22 directly below the opening 36B, an airflow generated inside the well 22 is able to effectively bounce off the barb 42 of the opening 36B. As a result, contamination can be relatively effectively reduced.

### Embodiment 3

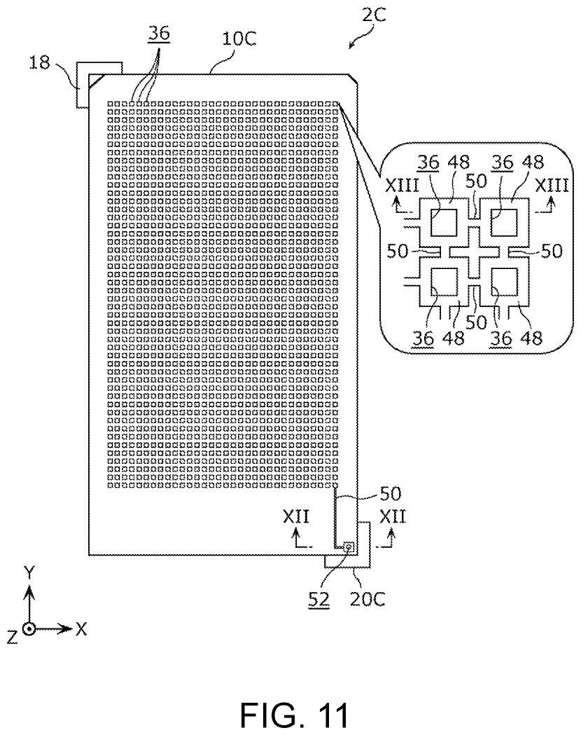

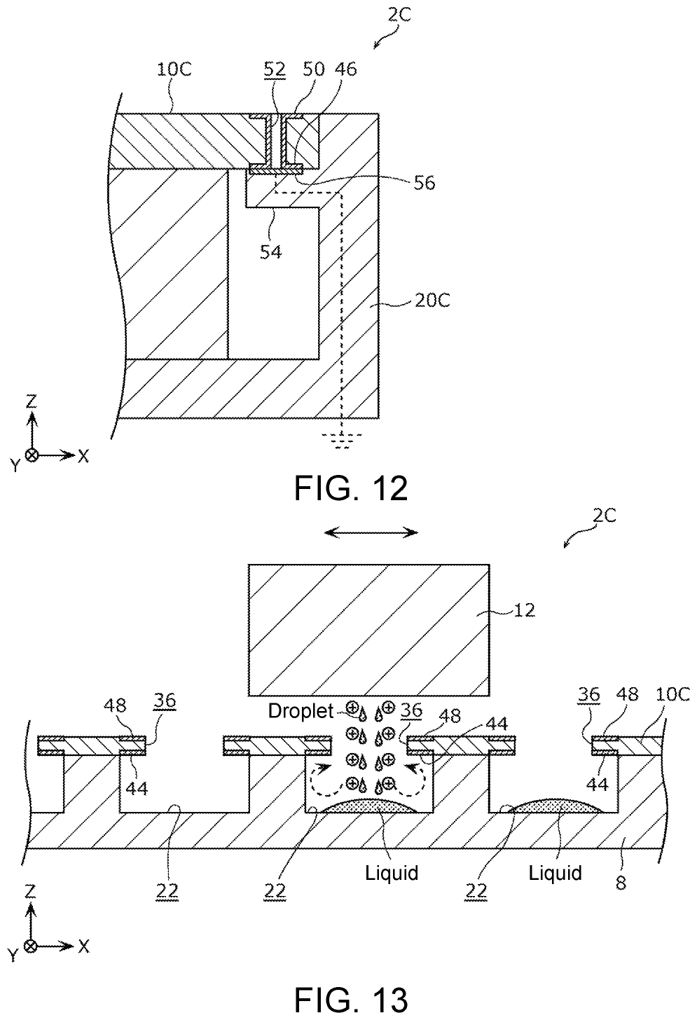

A configuration of a liquid dispensing device 2C according to Embodiment 3 is described with reference to FIG. 10 to FIG. 13. FIG. 10 is a plan view illustrating a lower surface side of an opening plate 10C of the liquid dispensing device 2C according to Embodiment 3. FIG. 11 is a plan view illustrating an upper surface side of the opening plate 10C of the liquid dispensing device 2C according to Embodiment 3. FIG. 12 is a cross-sectional view illustrating an essential part of the liquid dispensing device 2C according to Embodiment 3, taken along line XII-XII in FIG. 11. FIG. 13 is a cross-sectional view illustrating an essential part of the liquid dispensing device 2C according to Embodiment 3, taken along line XIII-XIII in FIG. 11.

In the liquid dispensing device 2C, the opening plate 10C is composed of, for example, a printed wiring board. As illustrated in FIG. 10, on a lower surface (that is, the surface facing the well plate 8) of the opening plate 10C, a plurality of first electrodes 44 are arranged on the outer periphery of each of the plurality of openings 36. Each of the plurality of first electrodes 44 is made of, for example, copper foil, and is formed in, for example, a rectangular ring shape as viewed in the XY plane, so as to surround the entire circumference of the opening 36. The plurality of first electrodes 44 are electrically connected to each other by a conductive pattern 46 made of copper foil or the like.

As illustrated in FIG. 11, on an upper surface (that is, the surface opposite to the well plate 8) of the opening plate 10C, a plurality of second electrodes 48 are arranged on the outer periphery of each of the plurality of openings 36. Each of the plurality of second electrodes 48 is made of, for example, copper foil, and is formed in, for example, a rectangular ring shape as viewed in the XY plane, so as to surround the entire circumference of the opening 36. The plurality of second electrodes 48 are electrically connected to each other by a conductive pattern 50 made of copper foil or the like.

As illustrated in FIG. 10 to FIG. 12, a through hole 52 is formed in a corner of the opening plate 10C. The conductive pattern 46 formed on the lower surface of the opening plate 10C and the conductive pattern 50 formed on the upper surface of the opening plate 10C are electrically connected via the through hole 52. As illustrated in FIG. 12, a guide wall 20C includes a support 54 and a grounding electrode 56. The support 54 protrudes from a side surface of the guide wall 20C and supports the lower surface of the opening plate 10C. The grounding electrode 56 is formed on an upper surface of the support 54 and is electrically connected to the conductive pattern 46 of the opening plate 10C. The grounding electrode 56 is grounded via, for example, an earth wire (not illustrated). That is, each of the plurality of first electrodes 44 and the plurality of second electrodes 48 is grounded via the grounding electrode 56.

For example, when the opening plate 10C is taken out from a plastic packaging bag or the like, even if the opening plate 10C is charged with charges (for example, positive charges), the charges on the opening plate 10C can be caused to flow to the ground via each of the plurality of first electrodes 44 and the plurality of second electrodes 48. As a result, as illustrated in FIG. 13, in the case where the droplets discharged from the discharge part 12 are charged with charges (for example, positive charges), it can be prevented that these droplets repel against the charges on the opening plate 10C and scatter to the outside of the well 22.

Although not illustrated, various electronic components may be mounted on the opening plate 10C. For example, an acceleration sensor and a communication module may be mounted on the opening plate 10C. The acceleration sensor detects an inclination of the opening plate 10C with respect to a horizontal plane (XY plane). The communication module wirelessly transmits a detection signal from the acceleration sensor to the controller 16 (FIG. 1) by a communication method such as Bluetooth (registered trademark) Low Energy (BLE). If the controller 16 determines that the opening plate 10C is inclined with respect to the horizontal plane based on the detection signal received from the communication module, the controller 16 stops the discharge of droplets from the discharge part 12.

### (Modifications)

Although the liquid dispensing device according to each embodiment of the disclosure has been described above, the disclosure is not limited to each embodiment described above.

In each embodiment described above, a plurality of wells 22 are configured to be formed in the well plate 8. However, the disclosure is not limited thereto, and a single well 22 may be configured to be formed in the well plate 8. In this case, in the opening plate 10 (10A, 10B, 10C), a single opening 36 (36B) may be configured to be formed corresponding to the single well 22.

In each embodiment described above, the well 22 and the opening 36 are both of a rectangular shape as viewed in the XY plane. However, the disclosure is not limited thereto, and the well 22 and the opening 36 may be of any shape such as a polygonal shape or a circular shape. For example, the well 22 may be of a polygonal shape as viewed in the XY plane, and the opening 36 may be of a circular shape as viewed in the XY plane.

If there is a configuration for suppressing charging in the opening plates 10B and 10C as in Embodiments 2 and 3 described above, the size of the opening 36 with respect to the size of the well 22 is preferably 80% or less. In this case, a well plate in which the number of wells 22 is 384 or 1536 is suitable for the well plate 8. On the other hand, if there is no configuration for suppressing charging in the opening plates 10B and 10C, in order to prevent droplets from scattering to the outside of the well 22 due to charge repulsion, the size of the opening 36 with respect to the size of the well 22 is preferably 60% or less. In this case, a well plate in which the number of wells 22 is 24 or 96 is suitable for the well plate 8.

The disclosure can be applied, for example, as a liquid dispensing device for dispensing a liquid such as a reagent to a well plate.

What is claimed is:

1. A liquid dispensing device, dispensing a liquid to a well plate having a well formed in an upper surface, wherein the liquid dispensing device comprises:
a discharge part, discharging the liquid toward the well; and
an opening plate, arranged between the discharge part and the well plate and having an opening formed therein corresponding to the well, wherein
the opening is smaller in size than the well in a plan view of the opening plate.

2. The liquid dispensing device according to claim 1, wherein,
in a plan view of the opening plate, the opening is smaller in size than the well, and an outline of the opening is arranged inside an outline of the well.

3. The liquid dispensing device according to claim 1, wherein
a lower surface of the opening plate facing the well plate has water repellency.

4. The liquid dispensing device according to claim 3, wherein
the lower surface of the opening plate has water repellency with a contact angle of 90° or more.

5. The liquid dispensing device according to claim 1, wherein
the opening plate is made of a conductive material.

6. The liquid dispensing device according to claim 1, wherein,
on a lower surface of the opening plate facing the well plate, a first electrode is arranged on an outer periphery of the opening; and
the first electrode is grounded.

7. The liquid dispensing device according to claim 6, wherein,
on an upper surface of the opening plate opposite to the well plate, a second electrode is arranged on the outer periphery of the opening; and
the second electrode is grounded.

8. The liquid dispensing device according to claim 1, wherein
a barb curved toward the well is formed on an outer periphery of the opening.
